(19) United States
(12) Patent Application Publication
(10) Pub. No.: US 2003/0167184 A1
(43) Pub. Date: Sep. 4, 2003

(54) Software based method for tracking rejected medicare and other insurance claims

(76) Inventor: Mark Hamilton Kole, Port Charlotte, FL (US)

Correspondence Address: FRANK A. LUKASIK, 1250 WEST MARION AVE., #142, PUNTA GORDA, FL, 33950, US

(21) Appl. No.: 09/793,183

(22) Filed: Feb. 26, 2001

(51) Int. Cl. G06F 17/60

(52) U.S. Cl. 705/2; 705/4

(57) ABSTRACT

The present invention is a method for using a computer to facilitate the tracking of Medicare and other medical insurance claims by care providers. The present invention relates to a dedicated software program which maintains a database of claim resubmission/review protocols for Medicare and insurance companies and interactively guides the user through all stages of the claims resubmission process to the end of either having a claim paid or disallowed for payment.

### BACKGROUND OF THE INVENTION

1. Field of the Invention

The present invention relates to dedicated software for tracking rejected Medicare and other Medical Insurance claims by care providers and more particularly to a software program which maintains a database of claim resubmission/review protocols for Medicare and Insurance companies and interactively guides the user through all stages of the claims resubmission process to the end of either having a claim paid or disallowed for payment.

2. Background

Medicare and other Medical Insurance carriers have strict protocols by which claims are resubmitted after being disallowed. These protocols progress generally through levels of approval/disapproval whereby at any given level a claim can be paid or not depending upon the applicant's compliance with the given protocols. Due to the complex nature of the medical insurance industry and the variety of coverages allowed (or disallowed) and the many jurisdictional areas governing the claims process, an administrative system of great complexity has evolved. For both the care provider and the Medicare/Insurance personnel the complexity of the system and failures to comply with its protocols have resulted in significant inefficiencies whereby valid claims simply get lost in the system often purely because they are directed to the wrong administrative office or have missed a procedural step. Claims are often abandoned by care providers because the amount of the claim becomes less than the cost of collecting it. The net result is that the system does not work well for either the Medicare/Insurance personnel who are often faced with the thankless task of rejecting numerous claims for procedural errors alone, or for care providers who must employ extra personnel to meticulously track each claim. Medicare's own figures show that 26%-29% of all claims initially are rejected and that of those claims, 77% are not resubmitted. Many ofthose not resubmitted are abandoned because of confusion over the reasons for the rejection and ignorance of the correct procedure for resubmission. Medicare and other Insurance carriers make training available for care providers to teach them the system but the system has become so complex that few acquire sufficient skill to make claims processing viable for their employers. This causes a disservice to the care provider who may not get paid for all the service he/she has delivered ultimately this penalization of the care givers, if for none other than financial reasons, could and sometimes does, result in diminished health care for the patient. By Federal Law, Medicare is required to police the validity and honesty of the claims as a result of abuses in the past by a minority of individuals seeking to defraud the system. Part of the policing procedure involves watching response times by care providers to initial rejections of their claims. Chronically late responders are isolated for closer scrutiny of their claims whether or not their lateness is a result of unfamiliarity with the system or confusion with its protocols. In either of the latter cases, the assignment of a negative “profile” may be simply arbitrary and unwarranted. The present invention seeks to remedy these and other flaws in the system so that it will operate as it was intended by lawmakers to the mutual benefit of the patient, the healthcare provider and the insurance body responsible for reimbursement of all valid claims. Ironically, Medicare personnel are often unable to respond in a timely manner to claims, despite the fact that they too are constrained by Federal Statute to so do. The present invention, as will be shown, provides a state-of-the art computerized system which will increase the accuracy of Medicare/Insurance claims so as to virtually eliminate misdirected claims traffic, missed response deadlines (on either end of the claim cycle) incorrect forms and claims procedures filed out of their correct sequences.

### SUMMARY OF THE INVENTION

In a preferred embodiment the present invention provides a software method for health care providers to successfully interface with Medicare and other Medical Insurance carriers in the processing of insurance claims which have previously been rejected.

It is a further object of the invention to guide the health care provider sequentially through all procedures necessary for resubmission of priorly rejected claims.

It is a fisher object of the invention to maintain updateable data bases containing all forms, form letters, procedures, mailing addresses and other administrative information required for the processing of rejected medical insurance claims.

It is a further object of the invention to have scaleable applications which can be sized to the needs of those seeking to process priorly rejected claims—from a single individual at one end of the scale, to large multi-state medical service providers, hospitals chains as an example.

It is a further object of the invention to track the dates of submissions to the insurance carrier so as to remain within the time limits set by the insurance carriers for such submissions, and by so doing, maintain “acceptable” response rates and avoid any possibly arbitrary assignment of delinquency and negative “profile”.

It is a further object of the invention to prevent the care provider from missing steps in the resubmission sequence by requiring specific information concerning the rejection criteria to be entered into key fields on the computer monitor.

It is a further object of the invention to proactively prompt the care provider to the next step in the resubmission sequence. Whereas database software generally available is able to store, cross reference, regurgitate and otherwise process data concerning rejected claims, none actually move the process forward (based on stored protocols) by issuing prompts and lists of approaching response deadlines.

It is a further object of the invention to enable the user to locally or globally search for and sort specific information on any field, numerically or alphanumerically simply by selecting those find and search functions from any screen and “double clicking” them with the mouse.

It is a further object of the invention to provide such accurate printed output that the letters and forms generated are in strict compliance with regulatory requirements and can be read with minimal error by Optical Character Readers used by Medicare and other insurance carriers.

It is a further object of the invention to ensure that any rejected claim is resubmitted until it is paid or is finally rejected for valid reason as specified in the existing protocols and that the reason for rejection is not due to administrative error on the part of either the care provider or the insurance carrier.

It is a further object of the invention to provide a simple, “user friendly” interface for users. This is accomplished through the use of a series of screens which literally, walk the user through each level of appeal/resubmission while providing previews of all forms required at each level and be providing the following features;

Simple, one-time patient data entry.

Medicare claim tracking—using the same criteria defined by Medicare.

Automatic internal claims forwarding. Once data has been entered regarding a denial of claim.

History tracking to provide all historical data on every claim for later review.

Automatic claims organization.

Automatic deadline and due date calculation to help the user avoid missed deadlines.

Automatic aging calculation to warn the user of claims which are aging and due to expire.

Built in forms which provide neatly printed copies of every relevant form.

Automatic form filler which correctly fills out each form according to the claim.

Search features which permit the user to search any claim using different criteria for searches.

Self addressing which provides the user with correctly addressed correspondence to correct mailing addresses.

Claim status at-a-glance whereby each claim is displayed with a clear status code.

Reports at-a-glance whereby reports at each level are generated to include all fields such as what has been sent, what is working, what has been denied, what has been approved, complete patient history, fair hearing claims schedules and administrative law judge docket schedule for example.

What is due report, provides a report of all claims in due date order with all hearing and filing dates displayed.

These and other objectives of the present invention enable the user to pursue an orderly progression through the resubmission steps for denied benefit claims, in the case of Medicare for example, these steps include;

Medical Review.

Claim reconsideration.

Fair hearing.

Administrative Law Judge.

Judicial Review in Federal Court.

### BRIEF DESCRIPTION OF THE DRAWINGS

FIG. 1. is a block diagram representing a first screen of the program.

FIG. 2. is a block diagram representing a first screen of the program.

FIG. 3. is a block diagram representing a first screen of the program.

FIG. 4. is a block diagram representing a first screen of the program.

FIG. 5. is a block diagram representing a first screen of the program.

### DETAILED DESCRIPTION OF THE INVENTION

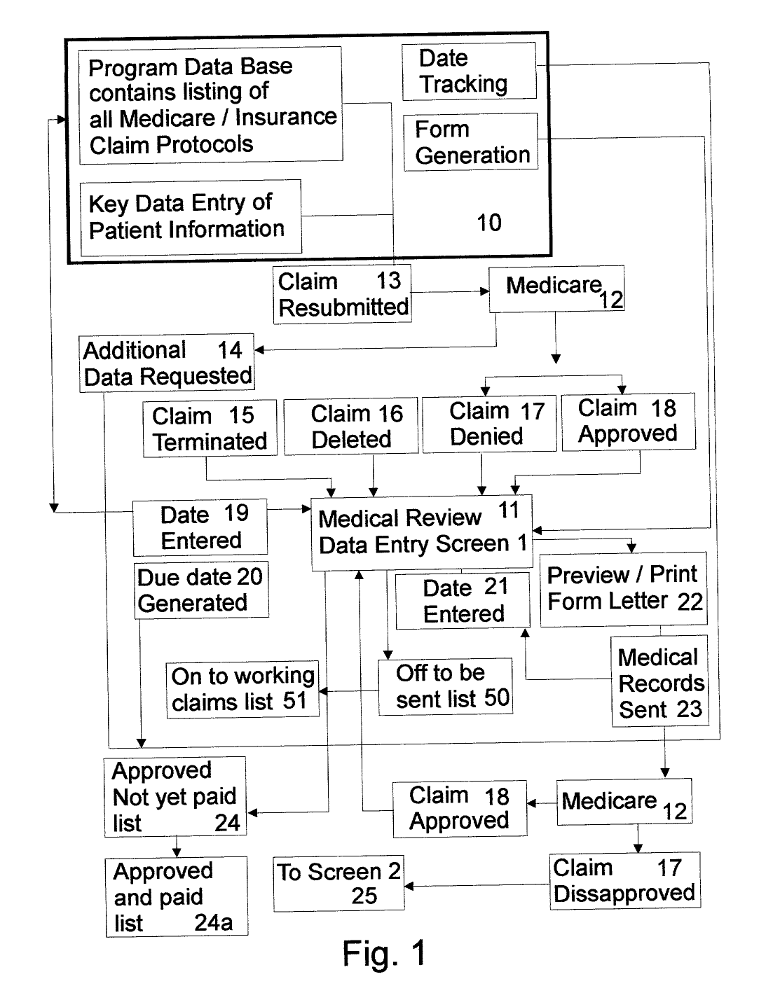

Referring now to the drawings wherein like numerals designate like and corresponding parts throughout the several views in FIG. 1., the first in a series of 5 appeal levels, core program 10 contains systems for storing Medicare/Insurance claim protocols, date tracking, form generation and facility to receive patient information from keyboard input. Claim resubmission 13 procedures are initiated upon the rejection of a claim by Medicare 12 or other insurance carrier. If the response from Medicare requires that additional data 14 is required, this fact is entered into Data Entry Screen one 11. Any forms used in such resubmission can be previewed and printed 22. Additional data is sent 23. The program meanwhile logs the date of this request 19 and thereafter tracks the event having generated a due date (30 days hence) 20 for the data to be sent. Once the data is sent 23, the date of this event is entered 21 and the program takes the claim off the to be sent list 50 and puts it on the working claims list 51. If Medicare 12 now approves the claim 18, that fact is input at Data entry Screen one 11 and the program adds that claim to the approved not yet paid list 24 or approved and paid list 24a. If Medicare 12 disallows the claim 17, the program moves this claim to screen two 25. Referring now to FIGS. 1-5, if at any time it is necessary to terminate a claim 15, delete a claim 16 or otherwise modify data concerning the claim or the patient, Data Entry Screens 1-5 (11, 26, 31, 38, 45) permit this interactivity. Said screens also permit the searching and sorting of data from any fields in the database of the program 10.

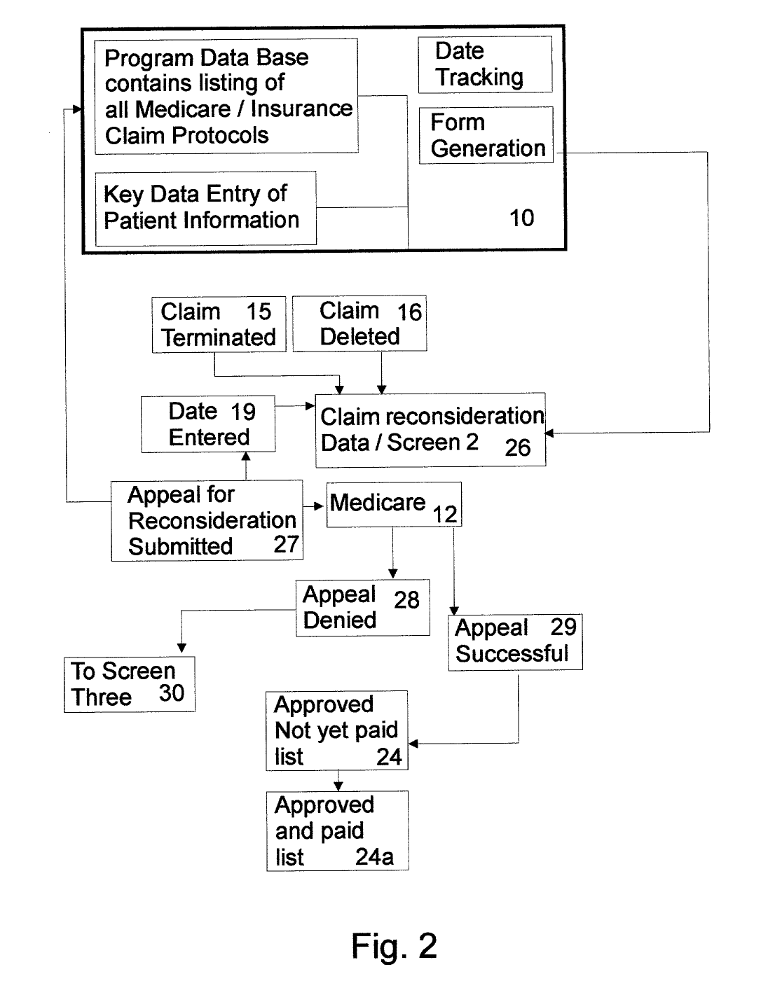

Referring now to FIG. 2, if the claim is not deleted 16 or terminated 15 an appeal for reconsideration 27 is submitted, again drawing from database data from program 10 for correct forms, addresses and relevant patient information. As before in screen one (FIG. 1) Medicare either approves the appeal 29 and the claim goes to the approved not yet paid list 24 or approved and paid list 24a, or the appeal is denied 28, and the matter continues now to screen three 30.

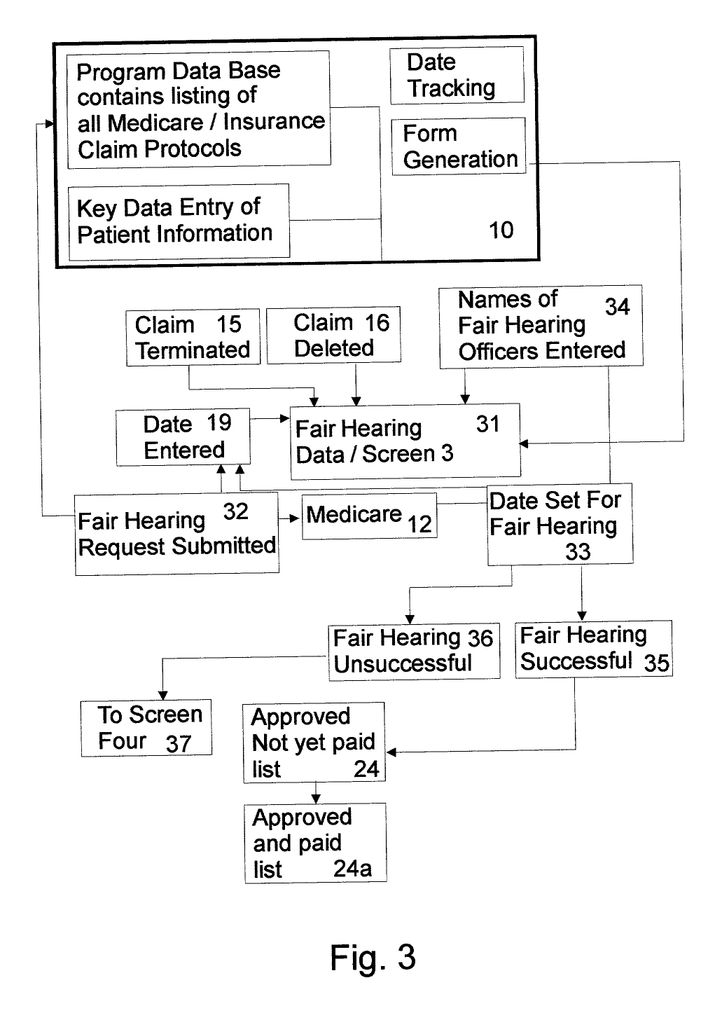

Referring now to FIG. 3, as before, if the claim is not deleted 16 or terminated 15 an appeal for Fair Hearing 31 is submitted, again drawing from database data from program 10 for correct forms, addresses and relevant patient information. Once Medicare 12 sets a date for a fair hearing 33 the relevant information concerning the hearing, including the date set and the hearing officers 34 is entered to be tracked by program 10. As before in screen one (FIG. 1) Medicare either approves the appeal 35 and the claim goes to the approved not yet paid list 24 or approved and paid list 24a, or the appeal is denied 36, and the matter continues now to screen four 37.

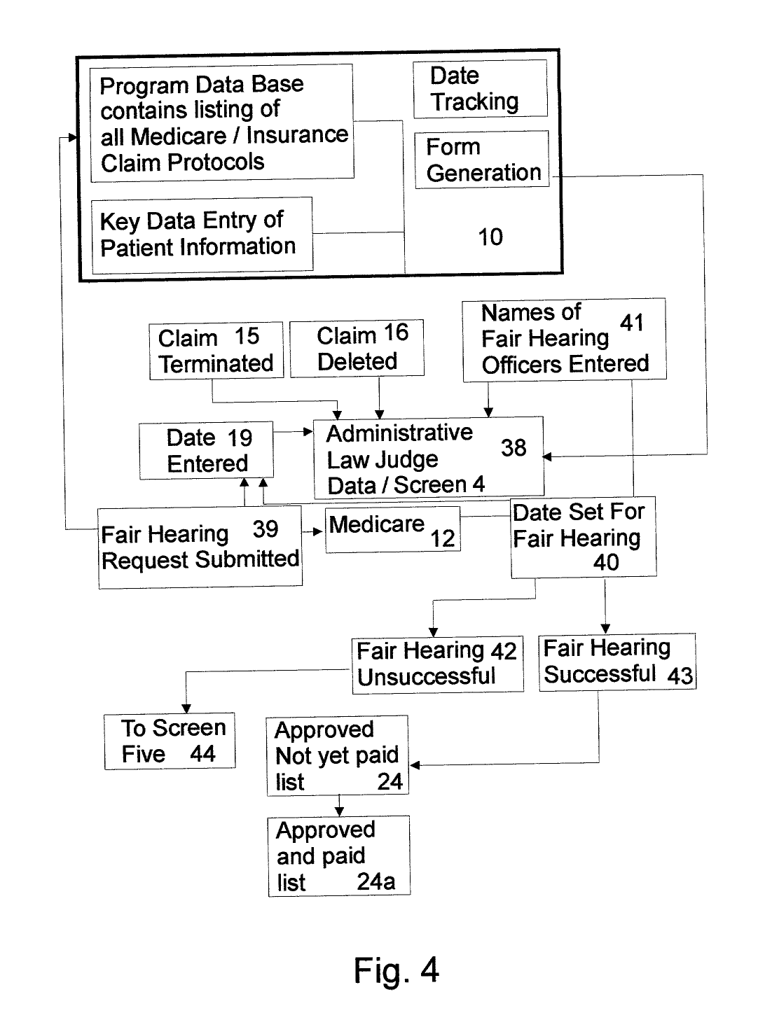

Referring now to FIG. 4, as before, if the claim is not deleted 16 or terminated 15 an appeal for Hearing before an administrative law judge 38 is submitted, again drawing from database data from program 10 for correct forms, addresses and relevant patient information. Once Medicare 12 sets a date for Hearing by administrative law Judge 40 the relevant information concerning the hearing, including the date set and the hearing officer 41 is entered to be tracked by program 10. As before in screen one (FIG. 1) Medicare either approves the appeal 43 and the claim goes to the approved not yet paid list 24 or approved and paid list 24a, or the appeal is denied 42, and the matter continues now to screen five 44.

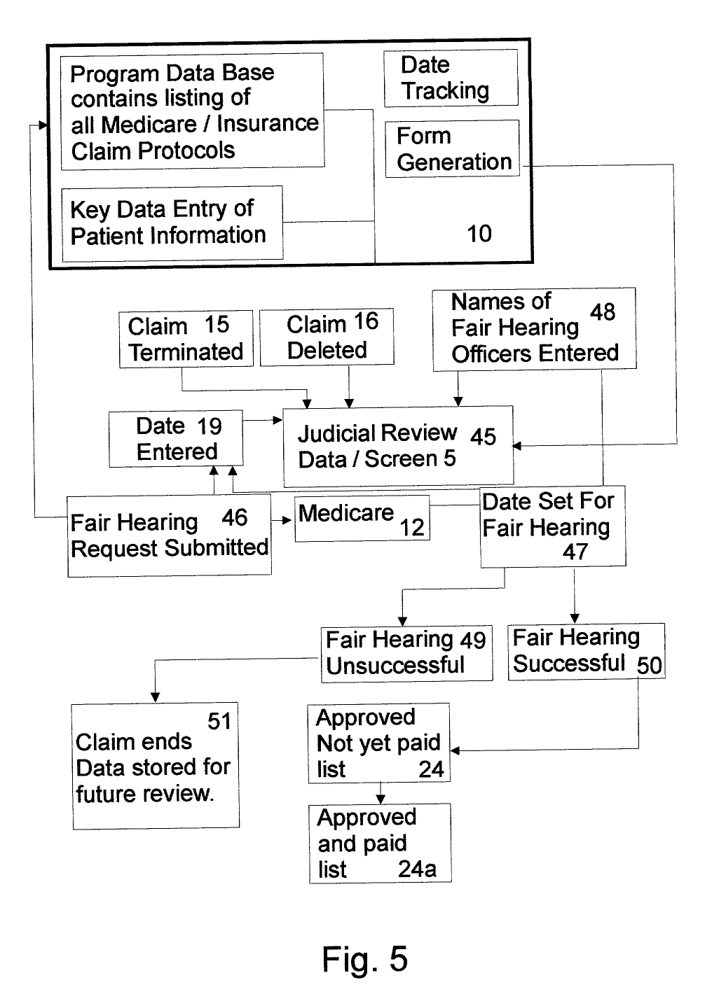

Referring now to FIG. 5, as before, if the claim is not deleted 16 or terminated 15 an appeal for Fair Hearing 46 is submitted, again drawing from database data from program 10 for correct forms, addresses and relevant patient information. Once Medicare 12 sets a date for a fair hearing 47 the relevant information concerning the hearing, including the date set and the hearing officers 48 is entered to be tracked by program 10. As before in screen one (FIG. 1) medicare either approves the appeal 50 and the claim goes to the approved not yet paid list 24 or approved and paid list 24a, or the appeal is denied 51 and the matter is now ended and all records concerning it remain in the database of program 10.

What is claimed is:

1. A method for using a computer to facilitate the tracking of Medicare and other medical insurance claims by care providers, said method comprising:
inputting into the computer, updateable data base, containing all forms, form letters, procedures, mailing addresses and other administrative information required for the processing of rejected medical insurance claims and providing accurate printed output that said letters and forms generated are in strict compliance with regulatory requirements and can be read with minimal error by optical character readers,
inputting into the computer, a data base for guiding the care provider sequentially through al procedures necessary for resubmission of priorly rejected claims,
inputting into the computer, scaleable applications which can be sized to the needs of those seeking to process priorly rejected claims on a scale from a single individual claim to large multi-medical service providers, and hospital claims,
inputting into the computer a data base for tracking the dates of submissions to the insurance carriers for maintaining acceptable response rates,
inputting into the computer a data base for preventing the care provider from missing steps in the resubmission sequence by requiring specific information concerning the rejection criteria to be entered into the key fields on the computer monitor,
inputting into the computer data base, proactive prompts and lists of approaching response deadlines, and
inputting into the computer data base, a series of screens for walking the user through each level of appeal/resubmission while providing previews of all forms required at each level.

2. The method of claim 1, in which the step of inputting into the computer, a data base for tracking the dates of submissions comprises:
inputting into the computer;
automatic deadline and due date calculation,
automatic aging calculation for warning the user of claims which are aging and due to expire,
automatic internal claims forwarding once data has been entered regarding a denial of claim,
claim status at-a-glance whereby each claim is displayed with a clear status code, and
automatic form filling which correctly fills out each form according to the claim.

3. The method of claim 1, in which the step of inputting into the computer, a data base for guiding the care provider sequentially through all procedures comprises;
inputting into the computer, reports at-a-glance whereby reports at each level are generated to include all fields such as what has been sent, what is working, what has been denied, what has been approved, complete patient history, fair claims schedules, what is due report, a report of all claims in due date order with all hearing and filing dates displayed, and administrative law judge docket schedule.

4. The method of claim 1, in which the step of inputting into the computer, a data base for guiding the care provider sequentially through all procedures comprise:
inputting into the computer;
Medicare claim tracking, using the same criteria defined by Medicare,
automatic claims organization, and
history tracking for providing all historical data on every claim for later review.
